(19) United States
(12) Patent Application Publication
(10) Pub. No.: US 2018/0101995 A1
(43) Pub. Date: Apr. 12, 2018

(54) SYSTEM AND METHOD FOR MANAGING A PARKING PROCESS OF A VEHICLE IN A PARKING ZONE WHICH IS SUBJECT TO CHARGES, AND FOR MANAGING A COUNTING PROCESS FOR PAYING PARKING CHARGES

(71) Applicant: Sunhill Technologies GMBH, Erlangen (DE)

(72) Inventor: Matthias MANDELKOW, Bubenreuth (DE)

(73) Assignee: Sunhill Technologies GMBH, Erlangen (DE)

(21) Appl. No.: 15/786,945

(22) Filed: Oct. 18, 2017

Related U.S. Application Data
(63) Continuation-in-part of application No. 15/526,169.

(30) Foreign Application Priority Data
Nov. 11, 2014 (DE) 10 2014 016 559.0

(51) Int. Cl. G07B 15/06; G07B 15/02; H04W 4/00; G06Q 50/30

(52) U.S. Cl. CPC G07B 15/063; G07B 15/02; G06Q 2240/00; H04W 4/008; G06Q 50/30; H04W 4/04

(57) ABSTRACT

A system and a method for managing a vehicle parking operation in a parking zone subject to fees, as well as a payment process for paying the parking fees. A system according to the invention comprises a control unit for controlling the parking operation and the payment process, wherein the control unit is connected to a communication network for transmitting signals; first means for identifying the user and/or the vehicle, which means are connected so as to communicate with the control unit; second means for identifying the process of entering, which means are connected so as to communicate with the control unit and/or the device for identifying the user; third means for realizing the identification, which means are connected so as to communicate with the control unit, wherein the third means are embodied for the identification in such a way that they detect the identification for the vehicle entrance in order to trigger and/or realize a payment process; fourth means which are embodied such and are connected so as to communicate with the control unit and/or the other means that they trigger a release; wherein the control unit is embodied to receive and process the identification signals via the communication network; wherein the control unit is embodied to generate an exit permission signal in response to a user transmitting the identification signals to the control unit; wherein the control unit is embodied such that it triggers and/or realizes the payment process immediately following the exit from the parking zone by using beacon devices for localizing the cell phone of the user of the vehicle and by activating the administrative operation for detecting the precise time when the vehicle enters and/or exits. The associated method serves to ensure a proper operation of the system.

A system and method for managing a vehicle parking operation in a parking zone subject to fees, as well as a payment process for paying said parking fees.

The present invention relates to a system for managing a vehicle parking operation in a parking zone subject to fees, as well as a payment process for paying said parking fees. The invention furthermore relates to a method for operating the system according to the invention Managing the parking operation is understood to mean the parking subject to fees in private and public parking spaces and/or barrier-controlled parking structures, which includes automatic payment transactions. Automatic payment transactions are defined as determining the parking fee following a specified parking period, debiting of the determined parking fee from an account of the vehicle user, and releasing the vehicle once the debiting from the account is complete.

Methods and systems are known from the prior art which support a predetermined parking in free parking zones, on individually localizable parking areas. Different approaches are used for this. In most cases, wireless signal transmission and, in particular, mobile radio transmission are used.

Specifically, a parking fee system is known from the WO 96/27170 A (Parkit Oy) which comprises a control unit with parking fee register by means of which a parking space can be assigned to the vehicle of a user, and the fees can be determined based on stored data for parking fees, as well as the associated information on the parking period, which can be called up from a user account.

A parking fee system is furthermore proposed in the WO 01/88 855 A (−EP 1 312 049 B1 (Payway Oy)), for which a parking fee center is activated by a parking ticket machine and which is connected via mobile telephone network to the user. Upon leaving the parking zone, an exit control device is activated via the parking fee center, using a ticket-specific exit permission code.

The WO 01/88 856 A (=EP 1312 050 B1 (Payway Oy)), on the other hand, proposes defining individual parking spaces for the parking operation and additionally storing the information for these parking spaces in the register of the parking fee center to determine the correct parking fees.

According to the older prior art, the unique feature of the aforementioned systems is that the payment function must always be realized when leaving the parking zone. To be sure, cell phone and mobile radio systems are already used for this, but the release of the barrier and, if applicable, the opening of the barrier only takes place when the payment process is completed. For the user, this results in a waiting period in front of the barrier.

Organizing the identification process with the aid of suitable means to simplify the management of the parking operation and the associated payment process for paying the parking fees has already been proposed in the older, not previously published international patent application PCT/EP2014/00215 (sunhill technologies GmbH, WuPa 01/14).

Starting with this premise, it is the object of the present invention to further improve the system proposed in the aforementioned patent application, as well as the associated method for operating the system.

This object is solved according to the invention by the total number of features listed in patent claim 1. Modifications relating to different aspects of the invention are the subject matter of the dependent device claims 2 to 19. To realize this system, a sequence of method steps is carried out as defined in patent claim 18 and/or patent claims 19 to 21.

It is essential for the invention that the technical means which communicate with the control unit utilize beacon devices. Beacons (“beacon lights”) are known as signal transmitters. The name iBeacon is a registered trademark of the company Apple Inc. Apart from that, the name has become established as a generic term in the technical field. The beacon devices derived therefrom, in short iBeacons, are proximity detecting systems and are viewed in modern technology as a new class of cost-effective transmitters which require little energy and can detect the presence of so-called IOS7 systems. Smartphone IOS7 operating systems, in particular, can thus be activated by the iBeacons to perform actions. However, they can also be used with Android and/or Windows operating systems for Smartphones.

Through the combined use of iBeacons for the entrance-barrier region or the exit barrier region and a suitable APP in the Smartphone, the precise time for the start and end of the parking period can now be detected. With this arrangement and using suitable logic units, the identification of vehicles and users and/or Smartphones is possible in a suitable manner.

To be sure, the use of Bluetooth technology between a control unit in the vehicle and a mobile phone is known for activating the barriers at the entrance and/or exit of parking zones provided with barriers. For this, we point in particular to the US2003/0224 766 A1 (EP 1 353 298 A1), the US2003/0050793 A1 and the US2004/0012481 A1. The individual barriers of the parking zones are thus activated via cell phone and SMS, once the registration and payment process are resolved. However, iBeacons are not specifically used for this.

As previously mentioned, the general use of specifically the beacon technology has been known for some time. Not known or also not suggesting itself, however, is the use for parking systems where specifically the iBeacons can execute different functions. Considerable economic advantages in particular result from the specific combination of iBeacons in parking systems with the registration of the user, as well as the detecting and managing of the parking fees.

For the realization of the invention, we can proceed on the assumption of a parking zone with traditional barrier. However, the use of beacons for solving the problem according to the invention is also advantageous for parking zones without barriers and on inner-city streets with separate parking lanes.

As an alternative to the presently used “parking ticket” with identifier, the invention respectively provides for different identification options to be allocated, in short called a Vticket, wherein iBeacons and a suitable Smartphone APP are used according to the invention. These communicate via Bluetooth, in particular Bluetooth Low Energy (BLE), which requires little energy.

For the purpose of the invention, so-called “digital” parking tickets are therefore used. A physical parking ticket is needed only in case of a malfunction. Otherwise, the process is handled exclusively via the above-mentioned media. As a result, virtual barriers can also be realized.

The parking duration and the amount to be paid are computed by the operator of the parking structure only after leaving the parking zone, for example the parking structure. The system for managing a vehicle parking operation in a parking zone subject to fees and a process for paying said parking fees subsequently debits this amount from the corresponding account of the user and notifies the user, e.g. via SMS.

If the parking fee cannot be paid via cell phone as a result of the service being temporarily unavailable, or if an exit signal cannot be generated, for example because of insufficient funds in the account, the parking space user is still liable for paying the fees. In that case, alternative payment options can be used, such as the cash register.

On the whole, it must be noted that the user generally does no longer receive and must keep a paper ticket. Consequently, there is no risk of the paper ticket being lost and that a corresponding “fine” must be paid, meaning a fee defined for such a case. In addition, the paper ticket use is reduced for the parking space administrator.

As previously mentioned, for the first time the invention can now be used for for parking spaces without barriers. For this, one or several iBeacons are assigned to the parking zone at a suitable position, wherein the iBeacons are connected contactless to the Smartphone and/or an associated APP in the Smartphone. In the future, it would be advantageous for the APP to be integrated into the digital system of the vehicle.

Further details and advantages of the invention follow from the description below of an exemplary embodiment in connection with the individual patent claims.

Shown are in

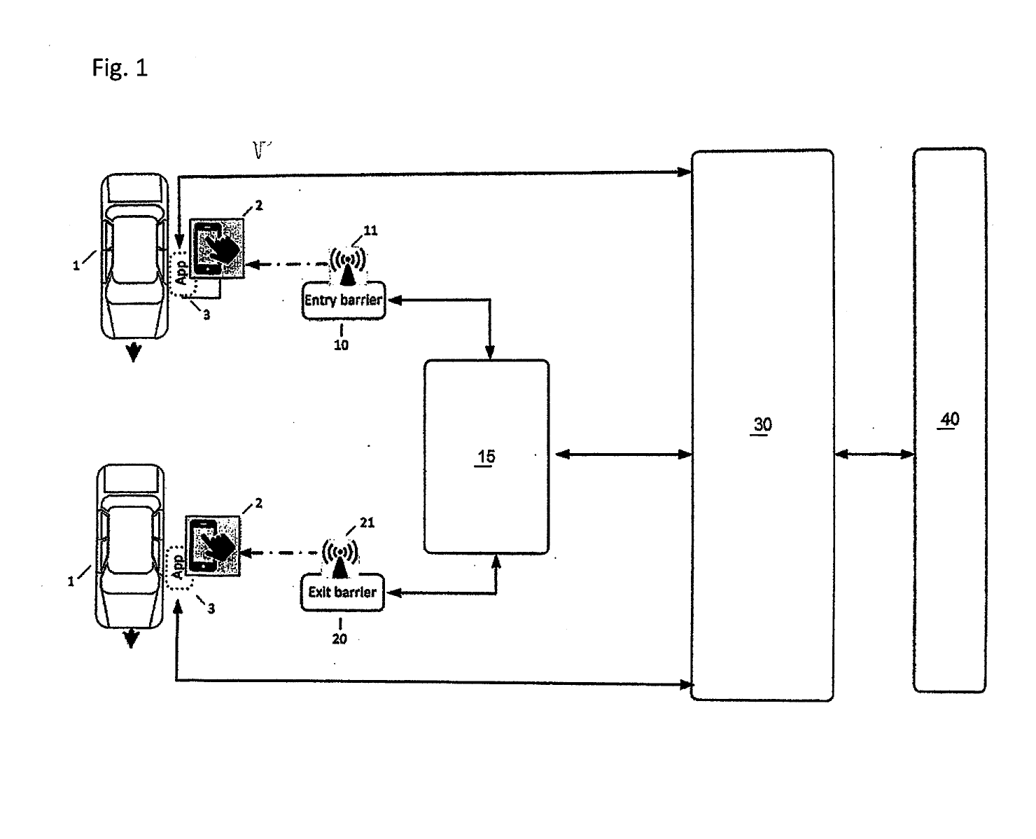

FIG. 1 a diagram for the use of iBeacons in a parking space and/or a parking structure using barriers and having entrance and/or exit blocking devices;

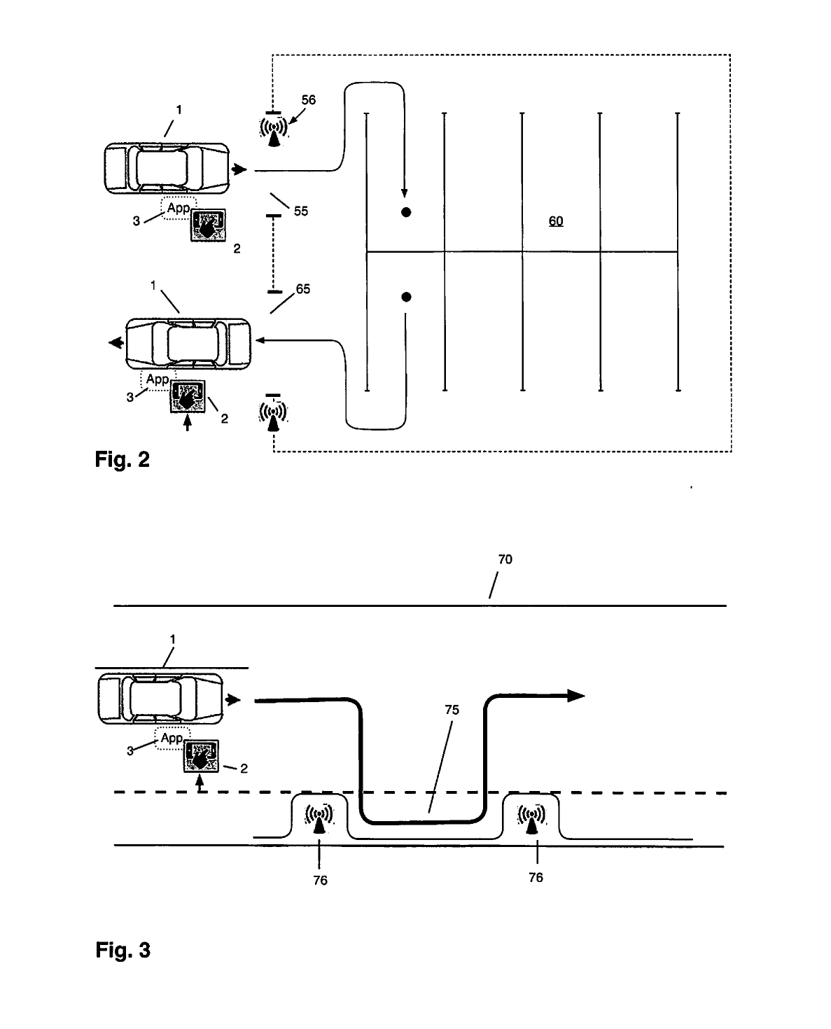

FIG. 2 the use of iBeacons for a parking space and/or a parking structure without entrance and/or exit blocking devices;

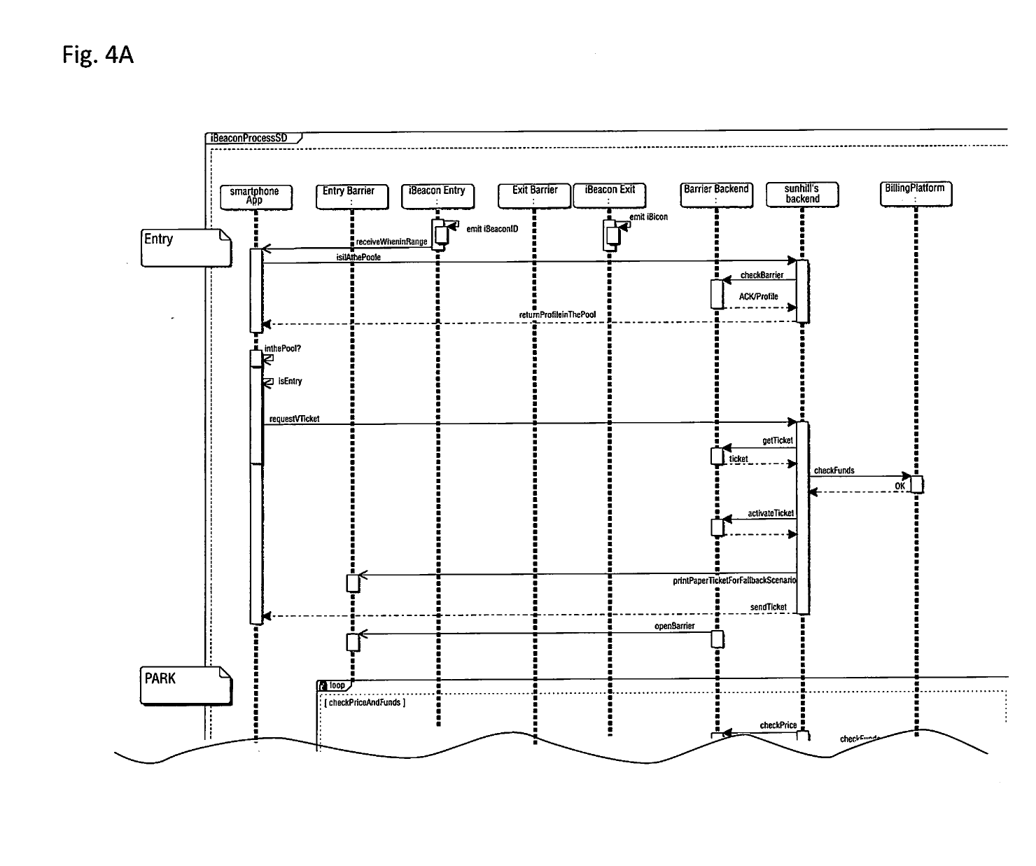

FIG. 3 the system with iBeacons for street parking; and

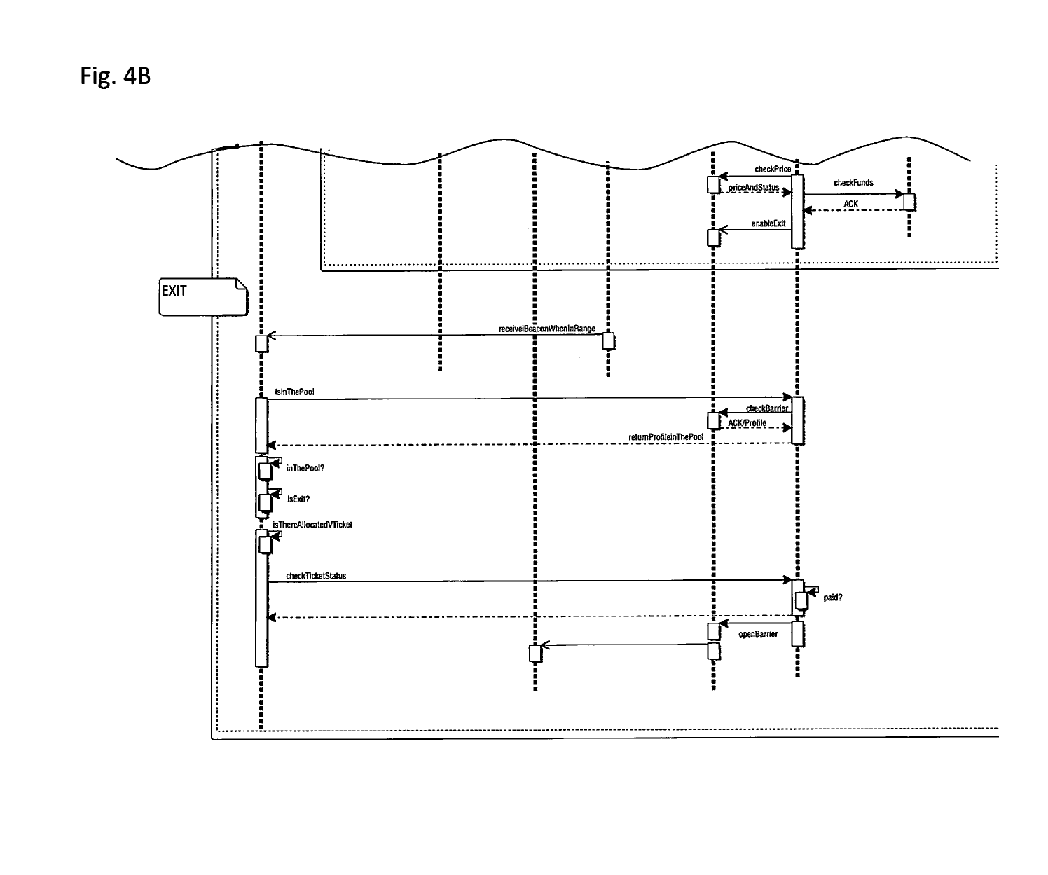

FIG. 4 the signal structure and/or adaptation of the respective beacon signals in the complete functional sequence;

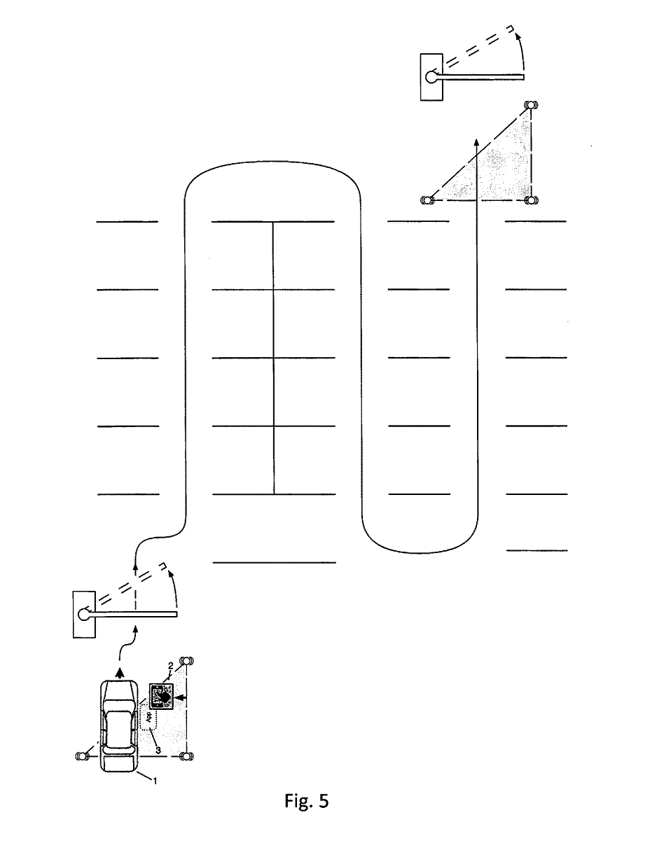

FIG. 5 the use of three iBeacons in a triangular arrangement, respectively at the entrance and the exit of a parking area separated by barriers, and

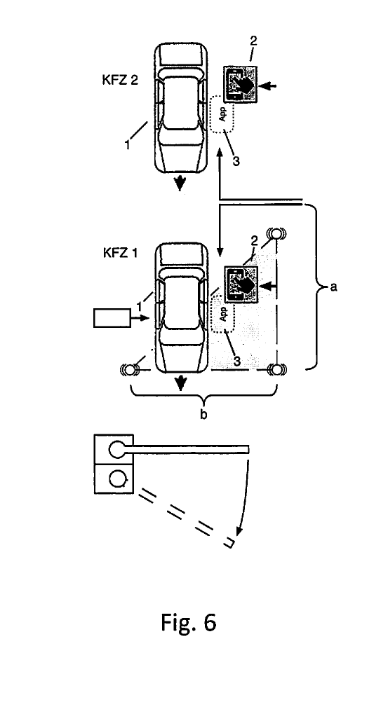

FIG. 6 an arrangement of this type for which an entrance barrier with ticket dispenser is assigned to a standard, delimited parking surface or to a parking structure.

In FIGS. 1 to 3, the number 1 respectively denotes a vehicle and/or a user of the parking system, located in a parking zone that is not characterized in detail herein, such as a parking garage, a parking space or also a street with parking lane. The user of the vehicle 1 has a Smartphone 2 which contains a specific application program 3 (APP). An APP of this type is available commercially, for example under the tradename of Travipay (registered trademark of the company sunhill technologies GmbH).

Specifically in FIG. 1, an entrance barrier 10 and an exit barrier 20 are shown. The entrance barrier 10 is assigned an iBeacon 11 and the exit barrier 20 is assigned an iBeacon 21. The entrance barrier 10 and the exit barrier 20 are connected to a barrier-control system 15, which has a communication link to a logic unit 30. For safety reasons, the supplier of the system (e.g. sunhill technologies GmbH) can communicate only via the logic unit 30 with the barrier-control system 15.

The logic unit 30 comprises an APP logic, a transaction logic, a garage business logic, and a calculation logic which are not described in detail. Also provided is a unit 40 (an accounting platform), which is used for generating bills and serves as the communication link with the logic unit 30.

The system described in this way is integrated into the system for managing the parking operation and for calculating the parking fees, as described in the older patent application PCT/EP2014/00215. The following individual steps are required when using it for a parking operation:

A requirement is that the user in the vehicle 1 has available an iBeacon-activated cell phone (Smartphone) 2 which is generally the case with newer Smartphones. If a Smartphone application (APP 3) is installed in this device, the systems of the parking garage and/or the parking zone with barriers can be activated with the iBeacon.

Once the vehicle 1 and/or the user with the cell phone 2 enters the transmission range of the iBeacon 11, the identity is received in the APP3 and transmitted further to the processing unit 30. For this, the iBeacon identity is read by the APP and is checked in the logic unit 30 against a system-specific pool. Insofar as the iBeacon is not stored therein, it is ignored. However, if it belongs to the stored pool, a barrier profile is sent to the APP. The APP then checks whether the barrier profile belongs to the entrance barrier 10.

The user receives a message asking whether he/she would like to receive a digital ticket. The user confirms that he/she would like a digital (virtual) ticket (Vticket). The vehicle must be parked with the engine turned off. Alternatively, the user can also indicate in the settings that the digital ticket is to be generated automatically, without manual confirmation. The user is then given a reference to the StVO if he/she wants to confirm.

The Vticket request is transmitted to the logic unit 30. The logic unit 30 then requests that the barrier-control system 15 generate a new, specific Vticket. The barrier-control system 15 generates a new Vticket and sends it to the logic unit 30. The logic unit 30 then sends the Vticket to the APP3.

In case of an error, meaning if the cell phone does not work (as a result of low battery or the like), a paper ticket can be printed if necessary.

The logic unit 30 activates the Vticket and sends it to the barrier-control system 15. The entrance barrier system opens the barrier 10 and the user can park the vehicle 1.

During the parking, either a one-time or a periodic accounting process is realized. In the first case, the payment amount is debited upon exiting the parking structure. In the second case, the amount respectively due for the parking is debited or allocated at specific time intervals. Following each debiting/allocating, the ticket status is renewed and the parking time is automatically renewed. If a problem occurs, in particular if the amount in the prepaid account is used up, the ticket is deleted and the user must pay the unpaid amount in the conventional way, using a paper ticket at a cash payment machine.

When leaving the parking garage, the reverse operation as for entering correspondingly takes place. The user drives the vehicle 1 to the exit barrier 20. The iBeacon 21 at the exist barrier 20 identifies itself in the APP3 on the user's Smartphone 2. The APP3 sends the iBeacon identity 11 to the logic unit 30, which checks the identity of the iBeacon 11 and ignores it if it is not part of the pool. The APP receives the barrier profile and checks whether this profile belongs to the exit barrier 20. The APP checks whether a digital Vticket was generated and also checks whether the payment amount makes sense and whether the amount has been paid, meaning debited. The APP 3 transmits via the logic unit 30 a signal for opening the exit barrier 20. The exit barrier 20 opens and the user can exit with the vehicle 1.

If a problem occurs with the iBeacon 21 or the user cell phone 2 (e.g. battery not charged), the user can insert the paper ticket obtained at the entrance barrier 10, if necessary, at the exit barrier 20. The ticket is then checked and the exit barrier 20 is raised once the amount is paid.

The number 50 in FIG. 2 refers to a free parking zone, having an entrance 55 and an exit 65. Respectively one iBeacon 56 and 66 is assigned to the entrance 55 and the exit 65. Several entrance and exit options can exist to which respectively one iBeacon is assigned. However, it is advantageous to have two iBeacons.

The number 70 in FIG. 3 refers to a street having a parking lane 75 on the side, on which at least one street parking space is realized. An iBeacon (pair) 76 is assigned to a street parking space of the parking lane 75.

A corresponding signal detection and paperless accounting can thus advantageously be realized for inner city parking locations in city parking zones. The following positions exist for this: Entry stands for the entering, Park for the parking duration, and Exit for the exiting. The individual stations represent the Smartphone APP, the entrance barrier, the Beacon at the entrance, the exit barrier, the Beacon at the exit, the final state of the barriers, the operator level and the accounting platform. The connecting arrows clearly illustrate the signal course which conforms to the operation of the system.

FIG. 4 shows a so-called sequence diagram for the exemplary embodiment according to FIG. 1. The vertical line here illustrates the time sequence and the horizontal line illustrates the individual stations for the managing and timely billing of the parking operation (business process).

In detail, the following process is realized:

### Entering:

1. The user has an iBeacon activated cell phone
2. The user drives into an iBeacon activated garage
3. In the operator area, the APP backend checks the iBeacon identity
4. The APP reads the backend identity and compares it to the operator pool
5. If the iBeacon is not
6. located in the operator area, the APP backend process checks the Beacon identity
7. The APP checks the operator backend to see if the iBeacon cooperates with the entrance barrier
8. The APP detects the notification
9. The user confirms that he/she would like to receive a digital ticket (so-called Vticket)
10. The request for a Vticket is forwarded to the operator backend
11. The operator backend communicates to the barrier backend the request for a ticket for the specific entrance
12. The barrier backend forwards a ticket to the operator backend
13. The operator backend delivers a Vticket
14. The operator backend activates the Vticket
15. The barrier system opens the entrance barrier

### Parking:

16. The user parks
17. The operator backend runs the accounting process in the background, either periodically debiting the user account or in agreement with the line of credit for the user.

### Exiting:

18. The user drives to the exit barrier
19. Within the scanning range of the iBeacon at the exit barrier, it identifies itself to the existing APP service of the user Smartphone
20. The APP checks the Beacon identity and suppresses the notification if it is not part of the operator pool
21. The APP is sent the Beacon profile and checks whether it corresponds to the exit barrier
22. The APP checks whether an active Vticket exists
23. The operator backend instructs the barrier backend to open the barrier
24. The barrier opens and the user drives out
25. In case of an error or malfunction, a paper ticket is generated which can be paid in the conventional manner.

For FIG. 2 and FIG. 3, that is when realizing the invention without barriers, a corresponding sequence diagram is obtained, but without the stations for the entrance/exit barriers.

In conclusion, it must be noted that with the system described with the aid of FIGS. 1 to 4, the iBeacons function to detect the parking time and, following the verification of the user in the logic unit, also function to trigger actions such as the opening of barriers, corresponding to FIG. 1, but also to connect the specific operator APP and to detect the identity of the user. In any case, the individual parking time utilized by the user can thus be determined and the account settled.

For parking zones without barriers—as indicated in FIGS. 2 and 3—the iBeacons serve exclusively to determine the start and the end of the parking period subject to fees. This is achieved via a modified signal course, corresponding to the signal sequence in FIG. 4. The advantageous characteristics of the system are also essential in this case, such as:

a) The user pays the parking fee via a Smartphone with APP; there is no need to wait in front of the ticket booth.
b) The payment is made directly via the payment platform, either with a credit card or through direct debiting from the account (SEPA).
c) The user can at any time activate a ticket via the Smartphone with APP, not necessarily when exiting the parking garage. This results in flexibility, and overpayments for unpaid parking periods are avoided.
d) The activated ticket is paid automatically upon leaving the parking zone.

As previously mentioned, the word “beacon” is derived from the English term “beacon light” which already describes the functional principle quite precisely, wherein the iBeacon at the present time defines a precisely defined technical component.

The beacon technology is based on a transmitter-receiver principle. Small transmitters (iBeacons) are positioned in the space for this, which function as signal transmitters that transmit signals at fixed time intervals. If a receiver—e.g. a Smartphone with installed application program (APP) which is configured for receiving iBeacon signals—comes within range of a transmitter, the so-called “universally unique identifier” (UUID) strength of the transmitter, meaning of the iBeacon, and the signal strength can be measured.

If at least three iBeacons are within range of the end device, the position of the receiver can be computed in the two-dimensional space, for example through trilateration or the so-called fingerprinting method. To determine a location in a three-dimensional space, four iBeacons would have to be within range.

However, iBeacons themselves cannot send push messages to receiving devices or collect and store user data. They only transmit information relating to their own identity (the values UUID, Major and Minor).

Since the vehicles move inside a parking structure and/or a parking zone in a single plane for the purpose of monitoring the entrance and/or the exit, three iBeacons are sufficient in that case. Individual vehicles can thus be identified precisely and without confusion during a concrete realization with vehicles driving closely one behind the other. Data is transmitted via Bluetooth Low Energy (BLE) technology which, as is known, operates with extremely low amounts of energy.

The latter is made clear in the following with the examples shown in FIGS. 5 and 6.

The number 80 in FIG. 5 relates to a parking zone and/or a parking space enclosed by a border 85 and accessible via barriers. There is an entrance 81 with entrance barrier 83 where the vehicles 1 can enter into the parking zone 80, with therein marked parking spaces, as well as an exit 82 for exiting the parking zone 80. The vehicle 1 is connected via an APP 3 [not 2], the Smartphone 2 of the user, and via Internet-supported mobile radio to the evaluation and control networks according to FIG. 1, wherein this is not shown in further detail herein.

It is essential that respectively three iBeacons 85, 85′ and 85″ are positioned in the region of the entrance 81 and respectively three iBeacons 86, 86′ and 86″ are positioned in the region of the exit 82, meaning in a triangular arrangement. A precisely defined region which is smaller than the vehicle length is thus covered by the monitoring,

This arrangement ensures that respectively one specified vehicle is detected and recorded, and misidentifications are practically impossible.

The triangular iBeacon arrangement with three iBeacons can also be advantageously used for existing parking spaces and/or parking structures with ticket dispensers for paper tickets, as well as for entrance and exit barriers.

In FIG. 6, a ticket dispenser located at a parking space entrance is given the reference 130 and an entrance barrier is given the reference 140. The entrance barrier 140 is alternatively shown open or closed (140′). In the entrance region, three iBeacons are arranged in a geometric triangle. The area covered by the three iBeacons can be specified in a suitable manner through defined distances a, b.

An arrangement of this type ensures that respectively one specified vehicle is identified and recorded and the entrance barrier is thus opened. The same type of arrangement exists for the exit barrier. Faulty openings of barriers are securely avoided in this way.

The above-described iBeacon arrangements in particular make it possible to distinguish between two vehicles driving closely one behind the other, KFZ1 and KFZ2, as shown in FIG. 6. With these iBeacon arrangements in a specified geometric arrangement, even existing parking structures can be supplemented and activated with iBeacons in a specified geometric arrangement, thus avoiding vehicle backups at the entrances and/or exits

Owing to the monitoring and identification of the vehicles with the described triangle-iBeacon arrangement, it may be possible to omit the entrance barrier 83 and the exit barrier 84 in FIG. 5, if applicable, thus completing a so-called “geo fence” around the parking zone 80. For safety reasons, a simple optical camera could be installed at the open exit 82 in order to record the license plates of users who do not pay.

With the invention, the arrangements shown in FIGS. 2, 3 and 5 and/or 6 can also be combined. Given the fact that the cost for commercially available iBeacons, in particular, is only a fraction of the cost for an optical camera with specific detection software, but also of other types of sensor arrangements, even the use of a multitude of iBeacons results in a considerable savings, as compared to the known solutions, wherein the identification security of vehicles is improved considerably.

### REFERENCE NUMBER LIST

### FIG. 1/FIG. 2/FIG. 3

1 vehicle/user
2 cell phone (Smartphone)
3 Smartphone APP

### FIG. 1

10 entrance blocking device
11 iBeacon
15 logic control unit
20 exit blocking device
21 iBeacon
30 logic unit
40 payment processing platform

### FIG. 2

50 parking zone
55 entrance
56 iBeacon
65 exit
66 iBeacon

### FIG. 3

70 street
75 parking lane
76 iBeacon
   FIG. 4 Sequence diagram

### FIG. 5

80 parking zone
85 border; geo fence
81 entrance region
82 exit region
83 entrance barrier
84 exit barrier
85, 85′, 85″ iBeacons
86, 86′, 86″ iBeacons

### FIG. 6

KFZ1 (vehicle 1)
KFZ2 (vehicle 2)
130 ticket dispenser
140 entrance barrier
triangle composed of 3 iBeacons
85, 85′, 85″ iBeacons

1. A system for managing a vehicle parking operation in a parking zone subject to fees, as well as a payment process for paying said parking fees, comprising
a control unit for controlling the parking operation and the payment process, wherein the control unit is connected to a communication network for transmitting signals;
first means for identifying the user and/or the vehicle, which means are connected so as to communicate with the control unit;
second means for identifying the process of entering the parking zone, which means are connected so as to communicate with the control unit and/or the means for identifying the user;
third means for detecting the time of the vehicle entrance, which means are connected so as to communicate with the control unit, wherein the third means are embodied to detect the identifier for the entrance of the vehicle in order to trigger and/or realize a payment process;
fourth means which are embodied in such a way and are connected so as to communicate with the control unit and/or the other means that they trigger a release for the exit of the vehicle;
and wherein the control unit is embodied to receive and process the identification signals via the communication network;
wherein the control unit is embodied for generating an exit permission signal in response to the user transmitting the identification signals to the control unit;
and wherein the control unit is embodied such that it triggers and/or processes the payment process as soon as the vehicle leaves the parking zone;
characterized by the use of beacon devices for localizing the cell phone of the user of the vehicle and activating the process of precisely and in a timely manner detecting the entrance and/or exit of the vehicle.

2. The system according to claim 1, characterized in that a Bluetooth Low Energy (BLE) technology is used for the beacon devices.

3. The system according to claim 1, characterized in that the beacon devices comprise so-called iBeacons.

4. The system according to claim 1, characterized in that respectively one barrier is present at the entrance and exit of the parking zone.

5. The system according to claim 1 characterized in that the transit through the entrance and the exit is unobstructed and that no barriers are provided at the entrance and exit of the parking zone, which must be clearly delimited, and that respectively one iBeacon is assigned to the entrance and one iBeacon to the exit.

6. The system according to claim 1, characterized in that for the case where no clearly delimited entrance and exit exists, at least one iBeacon is assigned to each parking area with at least one parking space (FIG. 3).

7. The system according to claim 1, characterized in that the signal processing and the selection of the iBeacon signals are controlled by Software.

8. The system according to claim 1, characterized in that means are provided for processing the iBeacon signals.

9. The system according to claim 1, characterized in that a so-called Vticket (virtual ticket) can be generated.

10. The system according to claim 1, characterized in that the cell phone of the user is a Smartphone which is provided with an application program that is suitable for detecting iBeacons.

11. The system according to claim 1, characterized in that at least one iBeacon is provided in each entrance and each exit region of the parking zone.

12. The system according to claim 1, wherein barriers are provided in the entrance and exit region, characterized in that the iBeacons are assigned to the barriers and control these barriers.

13. The system according to claim 16, characterized in that the iBeacons are connected so as to communicate with a control unit.

14. The system according to claim 13, characterized in that the control device is a control unit for monitoring and controlling the barriers.

15. The system according to claim 1, characterized in that logic units are provided for the APP on the cell phone, for operating the optional barriers, for managing the parking spaces, and for the accounting process.

16. The system according to claim 1, characterized in that the logic units are components of a computer unit for the administration of the APP logic, the activation logic, the parking space management logic and the accounting logic, which is connected so as to communicate with the control unit.

17. The system according to claim 1, characterized in that a user platform is provided for the billing, which is connected so as to communicate with the computer unit.

18. A method for managing a parking operation for a vehicle in a parking zone subject to fees, as well as a payment process for paying said parking fees, comprising a control unit for controlling the parking operation and the payment process, wherein the control unit is connected to a communication network, wherein this method involves the following steps:
generating information upon request from a user;
generating and issuing a user-specific identification;
releasing a user-specific access;
recording/reading in the information and the user-specific identification with answer-code;
wherein the control unit receives the answer-code via the communication network;
wherein the control unit generates an exit permission signal in response to a user transmitting the answer-code to the control unit;
wherein the control unit triggers and/or realizes the payment process as soon as the exit signal is generated, or was generated, and
wherein beacon devices are used for detecting the parking time.

19. The method according to claim 20, for which a parking zone with barriers exits,
wherein virtual parking tickets are generated
and wherein Smartphones with specific application programs (APPs) suitable for iBeacons are used.

20. The method according to claim 18, characterized in that the parking operation is controlled by the beacon signal.

21. The method according to claim 20, for which a parking zone without barriers exists,
wherein virtual parking tickets are used
and wherein Smartphones with specific application programs (APPs) suitable for iBeacons are used.

22. The method according to claim 19, characterized in that a beacon arrangement is used with three iBeacons in a triangular arrangement.

23. The method according to claim 22, characterized in that three iBeacons are used in a triangular arrangement at the entrance and at the exit of the parking zone.

24. The method according to claim 23, characterized in that the distance between the three iBeacons can be specified and can be changed.
